(19) United States
(12) Patent Application Publication
(10) Pub. No.: US 2023/0286110 A1
(43) Pub. Date: Sep. 14, 2023

(54) OPERATING A BLASTING SYSTEM USING CONTROL DATA

(71) Applicant: DyeMansion GmbH, Planegg (DE)

(72) Inventors: Julius LEGENMAJER, München (DE); Philipp KRAMER, München (DE); Joscha INNECKEN, München (DE); Maximilian SPES, München (DE); Lukas ERDT, München (DE); Hansjörg KAUSCHKE, Oberhaching (DE); Alexander ROSSMANN, München (DE)

(21) Appl. No.: 18/016,347

(22) PCT Filed: Jul. 15, 2021
(86) PCT No.: PCT/EP2021/069781

§ 371 Date: Jan. 15, 2023

(30) Foreign Application Priority Data
Jul. 16, 2020 (DE) 10 2020 118 828.5

(51) Int. Cl. B24C 9/00

(52) U.S. Cl. CPC B24C 9/006

(57) ABSTRACT

The invention relates to a method for operating a control logic of a blasting system (100), the blasting system (100) comprising at least one blasting nozzle (111) for blasting blasting material (91) into a process chamber (110) of the blasting system (100), wherein at least one component (90) can be arranged in the process chamber (110), wherein the blasting material (91) is supplied to the at least one blasting nozzle (111) from a blasting material exchange container (200) via a blasting material circuit (180, 181-185) of the blasting system (100), and wherein the method comprises: —receiving (3010) control data (70) from a logic element (201) of the blasting material exchange container (200) which is detachably arranged in the blasting material circuit (180, 181-185), and—operating (3015) the blasting system (100) on the basis of the control data (70).

### TECHNICAL FIELD

Various examples of the invention relate to techniques for operating a blasting system based on control data. For example, the control data may relate to blasting material used in the blasting system. Further examples of the invention relate to a blasting material exchange container which can be detachably arranged in a blasting material circuit of the blasting system.

### BACKGROUND

Blasting systems are used to treat the surface of components. An exemplary blasting system is described in DE19614555A1. In this case, blasting material (sometimes also referred to as blasting medium) is blasted into a process chamber of the blasting system by means of a blasting nozzle, wherein the components to be treated are located in the process chamber. The surface of the components is treated due to the physical effect of the exchange of particles between the blasting material and the surface of the components. For example, dirt or impurities can be removed from the surface, sharp edges can be smoothed, etc.

Blasting systems in this case can be used to treat the surfaces of various types of components. For example, blasting systems can be used for metallic components or also for plastic components. For example, plastic components are sometimes produced by a 3D printing process, for example in a powder bed process. An example of a powder bed process would be a selective laser sintering (LS) process in which the body of the plastic component is constructed in layers. The starting material from which the plastic components are made may be, for example, a polyamide or thermoplastic polyurethane. After completion of such a 3D printing process, it is then necessary to separate the plastic components from a so-called powder cake, which is usually done manually. This process is called unpacking. After unpacking, the separated components have powder in cavities and residue of thermally affected powder (caking) which must be removed. Such powder cake residue (hereinafter simply called powder) can be removed using the blasting system. This is also characterized as de-powdering of plastic components additively produced in the powder bed process.

There are also blasting systems known in which the blasting material is used multiple times, i.e., it is used in a closed blasting material circuit. The input of energy of the accelerated blasting material acting on the components can damage the blasting material upon contact with itself, the components, or parts of the system. In addition, material can be worn off of the component or powder can be deposited. Thus, the blasting process results in a mixture of (i) intact blasting material, (ii) damaged blasting material/blasting material residue, and (iii) material particles/powder from the component. (ii) and (iii) together can be referred to as dirt or waste. In addition, additional dirt from the environment can get into the mixture. It is therefore necessary to break down the mixture into its components, dispose of waste, and to regularly replenish the blasting material.

### BRIEF DESCRIPTION OF THE INVENTION

There is a need for improved techniques for providing blasting material for blasting systems in order to operate blasting systems reliably and with low maintenance and in order to ensure a constant, high level of process quality.

This object is achieved by means of the features of the independent claims. The features of the dependent claims define embodiments.

Various techniques for simplifying the operation of a blasting system are described in the following. Functional features which enable adaptive operation of the blasting system based on control data are also described. The control data may relate to the blasting material. The control data may be derived from a state measurement or can configure operation when predefined. However, there are also mechanical-structural features described which enable the provision of the blasting system with blasting material.

A method is described for operating a control logic of a blasting system. The blasting system comprises a blasting nozzle. The blasting nozzle is designed to blast blasting material into a process chamber of the blasting system. One or more components may be arranged in the process chamber. The blasting material is supplied to the blasting nozzle via a blasting material circuit of the blasting system, e.g. from a blasting material exchange container.

As a general rule, the blasting system may comprise one or more blasting nozzles.

In some examples, the method comprises the receiving of control data. For example, it would be conceivable for the control data to relate to the blasting material. For example, it would be conceivable for the control data to describe the state of the blasting material. Alternatively or additionally, it would be conceivable for the control data to relate to the blasting material exchange container, that is to comprise, for example, a serial number, a manufacturer, or other type information. Alternatively or additionally, it would be conceivable for the control data to specify one or more parameter values for operating parameters of the operation of the blasting system.

It is possible for the blasting system to then be operated based on the control data. Alternatively or additionally, the control data could also be stored—e.g. in a memory of the blasting material exchange container—or sent to a server or a database.

For example, the control data could be received from a logic element of the blasting material exchange container. The logic element may comprise, for example, a nonvolatile memory and/or a sensor. Alternatively or additionally, the control data may also be received from one or more sensors of the blasting system which are arranged along the blasting material circuit.

Provided the control data are received from the logic element of the blasting material exchange container, it would be conceivable for the control data to also be modified there, for example as a function of the operation of the blasting system. For example, if a state of the blasting material is described by the control data, this state can be individually adapted by adapting the control data in the memory of the blasting material exchange container.

The blasting material circuit may be closed, i.e. comprise a first section which leads from the blasting material circuit to the process chamber and a second section which leads from the process chamber to the blasting material circuit. A separating device, for example a sieve, which separates the blasting material from waste, may be arranged in the second section.

A computer program or a computer program product or a computer-readable storage medium comprises program code. The program code can be loaded and executed by a processor. The execution of the program code means that the processor executes a process for operating a control logic of a blasting system. The blasting system comprises a blasting nozzle. The blasting nozzle is configured for blasting blasting material into a process chamber of the blasting system. One of more components may be arranged in the process chamber. The blasting material is supplied to the blasting nozzle from one or more blasting material exchange containers via a blasting material circuit of the blasting system. The method comprises the receiving of control data. In addition, the method optionally comprises the operation of the blasting system based on the control data.

A blasting system comprises a control logic, a process chamber, and a blasting nozzle. In this case, the blasting nozzle is designed to blast blasting material into the process chamber. At least one component may be arranged in the process chamber. The blasting material is supplied to the blasting nozzle from a blasting material exchange container via a blasting material circuit of the blasting system. The control logic is configured to receive control data. In addition, the control logic is configured to operate the blasting system based on the control data.

As a general rule, it would be conceivable that the blasting system can be connected to more than one blasting material exchange container. This means that the blasting material can be suctioned from the blasting material exchange container and/or one or more further blasting material exchange containers. Such a selection of one or more sources of the blasting material can be carried out, for example, based on the control data.

In this case, it would be conceivable for the different blasting material exchange containers to be associated with different processes. For example, a first blasting material exchange container could store blasting material which can be used for de-powdering, while a second blasting material exchange container can store blasting material for a surface treatment/for the compression. The respective process can be indicated by the control data.

A blasting material exchange container comprises a canister. The canister is designed to receive or to store blasting material. The blasting material exchange container further comprises a connecting element. The connecting element is attached to the canister and comprises a closure plate. The closure plate closes an opening in the canister. The connecting element further comprises at least one suction lance which extends through the closure plate into the canister and is designed to suction the blasting material into a blasting material circuit of a blasting system by means of a vacuum. In addition, the connecting element also comprises at least one coupling nozzle. This coupling nozzle is fluidly coupled to at least one suction lance. In addition, the at least one coupling nozzle is arranged outside of the closure plate as relates to the canister. The at least one coupling nozzle is designed to produce a sealing connection between the suction lance and the blasting material circuit of the blasting system and that is via at least one corresponding coupling nozzle of the blasting system.

A blasting system comprises a process chamber. This process chamber is designed to receive at least one component. The blasting system further comprises a blasting nozzle. The blasting nozzle is designed to blast blasting material into the process chamber. The blasting system also comprises a blasting material circuit which is designed to convey the blasting material to the blasting nozzle and to discharge it from the process chamber. In addition, the blasting system comprises at least one connecting element with at least one coupling nozzle. The at least one coupling nozzle is designed to produce a sealing connection between at least one suction lance of at least one blasting material exchange container and the blasting material circuit via at least one corresponding coupling nozzle of a blasting material exchange container.

A blasting system comprises a process chamber. This process chamber is designed to receive at least one component. The blasting system further comprises a blasting nozzle. The blasting nozzle is configured to blast blasting material into the process chamber. The blasting system also comprises a blasting material circuit which is designed to convey the blasting material to the blasting nozzle from a canister of a blasting material exchange container and to discharge it from the process chamber. In addition, the blasting system comprises at least one connecting element with at least one suction lance. The at least one suction lance can extend into the canister of the blasting material exchange container when the connecting element of the blasting system is coupled to a further connecting element of the blasting material exchange container.

A blasting system has a closed blasting material circuit. The blasting system comprises a process chamber. This process chamber is designed to receive at least one component. In addition, the blasting system comprises at least one blasting nozzle. This blasting nozzle is designed to suction blasting material along the blasting material circuit and to blast it into the process chamber. Furthermore, the blasting system has a collection container. This collection container is arranged along the blasting material circuit downstream starting from the process chamber. The blasting system further comprises a valve, e.g. a pinch valve. This valve is arranged at an outlet of the collection container. Upon opening, this valve is designed to supply blasting material along the blasting material circuit of a separating device of the blasting system. The separating device is designed to separate the blasting material from waste.

The previously shown features and features to be described in the following can be used not only in the corresponding explicitly shown combinations but also in further combinations or in isolation, without going beyond the protective scope of the present invention.

### BRIEF DESCRIPTION OF THE FIGURES

FIG. 1 schematically illustrates a blasting system as well as a blasting material exchange container and a waste container, which are connected to a blasting material circuit of the blasting system according to various examples.

FIG. 2 is a flowchart of an exemplary method.

FIG. 3 illustrates the weight of the blasting material in the blasting material exchange container as a function of time according to various examples.

FIG. 4 illustrates the weight of the blasting material in the blasting material exchange container as a function of time according to various examples.

FIG. 5 illustrates the weight of the blasting material as a function of time and at two measurement sites in the blasting material circuit according to various examples.

FIG. 6 illustrates the weight of the blasting material in the blasting material exchange container as well as the aggregated throughput by weight as a function of time according to various examples.

FIG. 7 illustrates the weight of the blasting material in the blasting material exchange container as a function of time according to various examples.

FIG. 8 schematically illustrates the blasting material exchange container according to various examples.

### DETAILED DESCRIPTION OF EMBODIMENTS

The previously described properties, features, and advantages of this invention as well as the type and manner as to how they are achieved will become more clearly and noticeably understandable in the context of the following description of the exemplary embodiments, which are explained in greater detail in connection with the drawings.

In the following, the present invention is explained in greater detail by means of preferred embodiments, with reference to the drawings. The same reference numerals refer to equivalent or similar elements in the figures. The figures are schematic representations of various embodiments of the invention. Elements shown in the figures are not necessarily shown to scale. Rather, the various elements shown in the figures are reflected such that their function and general purpose will be understandable to one skilled in the art. Connections and couplings between functional units and elements shown in the figures can also be implemented as an indirect connection or coupling. A connection or coupling may be implemented wired or wirelessly. Functional units may be implemented as hardware, software, or a combination of hardware and software.

Techniques for operating a blasting system are described in the following. The techniques described herein relate particularly to aspects associated with a blasting material to be used in the blasting system. For example, aspects are described in association with the exchange of blasting material exchange containers. In addition, aspects are described in association with a closed blasting material circuit which conveys the blasting material from the blasting material exchange container and supplies it to a blasting nozzle or several blasting nozzles and, subsequently, returns the blasting material used in the blasting process back to the blasting material exchange container. Various aspects relate to the exchange of blasting material. Further aspects relate to the control of operation of the blasting system, for example based on information related to the blasting material (for example, a current state of the blasting material or the type of blasting material used). Operation of the blasting system can also be controlled based on data, for example control data which specify the operating parameter values or state data which describe the state of the blasting system, for example, in connection with the blasting material.

As a general rule, the most varied types of blasting material can be used in the methods described herein. Depending on the type, the blasting material can differ, for example, with respect to grain size, granularity, chemical composition, and morphology. Further characteristics include flow capacity, density, and electrostatic properties. One example would be blasting material made of plastic, glass, ceramic, or sand with a grain size of 200 μm to 600 μm.

With conventional operation of the blasting system with a closed blasting material circuit, the blasting material is replenished from time to time, for example depending on the elapsed blasting time, an empirically observed decrease in the processing quality, or a visual inspection of the blasting material by the user. With conventional techniques, the blasting material must be removed from a box or bag or unloaded into a container by hand. This may have the result that the operator comes into contact with the blasting material, which may be hazardous to health (fine dust). In addition, there may be an explosion hazard if blasting material is released into the environment, when the blasting material is agitated, for example.

Such disadvantages are eliminated by means of the techniques described herein. Specifically, various effects can be achieved by means of the techniques described herein. For example, the blasting material exchange container can be replenished especially easily and quickly. It is possible to switch between different blasting processes that use different blasting material especially easily and with fewer errors. Use of the wrong blasting material can be prevented. It is possible to detect errors associated with the use of the blasting material during operation of the blasting system, for example because the blasting material is dirty or the blasting material circuit has been disrupted, etc.

Such effects and others can be achieved, firstly, by means of the suitable, functional design of the control logic of the blasting system so that control data are considered during operation of the blasting system. The control data may relate to the blasting material exchange container and/or the blasting material itself. The control data can set the operation of the blasting system, e.g., in that certain commands are stored for setting the operating parameters. The control data can be obtained from memory chips and/or sensors, for example from the blasting material exchange container and/or from measurement sites in the blasting system itself. Operation of the blasting system can then be adjusted, for example, precisely to the blasting material and particularly to the current state thereof. This enables a consistently high quality of the processing of components. As an alternative or in addition to such a suitable, functional design of the control logic of the blasting system for considering the control data related to the blasting material, it would, secondly, be possible to design the mechanical interface between the blasting system and the blasting material exchange container such that it is possible to replenish the blasting material easily and reliably. To this end, the blasting system as well as the blasting material exchange container may comprise a respective connecting element, wherein these connecting elements may be designed to correspond mechanically such that a connection of lines for conveying and returning the blasting material can be established quickly and with reduced exposure of the environment to the blasting material. For example, corresponding coupling nozzles, which can be attached to one another and detached from one another, can be provided on the connecting elements for a supply line and a discharge line of the blasting material circuit, without a special tool being required.

As a general rule, the control data may be obtained from one or more different sources. Thus, it would be possible for the control data to be received from a logic element of the blasting material exchange container. The logic element may comprise a nonvolatile memory in which the control data are stored. The logic element may comprise, for example, an RFID transmitter with a memory chip. For example, information relating to the type of blasting material can be transmitted to the blasting system when a corresponding blasting material exchange container is connected to the blasting material circuit of the blasting system. In such a case, the blasting of the blasting material can then take place as a function of the type of blasting material—thus, e.g., the grain size, chemical composition, etc. The control data may also directly specify one or more operating parameters of the blasting system. The blasting nozzles can be actuated accordingly, i.e. a suction vacuum, for example, could be set. For example, a blasting strength, a blasting duration, and/or a blasting position could also be set depending on the type of blasting material. The blasting strength can be influenced by the quantity, suction and blasting pressure, and speed and acceleration of the blasting material; one or more such parameters can be set when the blasting strength is set. Alternatively or additionally, it would also be conceivable for the blasting pressure and/or the blasting duration to be set with ionized air depending on the type of blasting material. If the blasting system comprises several blasting nozzles, it would also be conceivable, for example, that control of the blasting of the blasting material comprises the switch-on or switch-off of individual ones of the several blasting nozzles based on the control data. This may mean that different blasting nozzles are used, for example depending on the type of blasting material in question. The different blasting nozzles may have, for example, different outlets so that the blasting angle can be modified depending on the type of blasting material. It would also be possible that the different blasting nozzles are positioned differently in the process chamber of the blasting system, based on the control data.

As an alternative to or in addition to such control data which are received from the blasting material exchange container, it would also be conceivable, however, that the control data are received from one or more sensors of the blasting system itself. Thus, it would be conceivable that one or more sensors are arranged at one or more measurement sites along the blasting material circuit. Such sensors may measure, for example, a flow rate of the blasting material or a weight in a buffer element or in a waste container or in the blasting material exchange container. For example, sensors can be used which describe a state of a filter for separating the blasting material from waste. For example, clogging of the filter could be determined.

Optical sensors can also be used which can detect, for example, dirt or a disruption in the blasting material. For example, blockages in the blasting material circuit can be detected in this manner. However, leaks can also be detected, for example. In addition, the functionality of a sieve or of a cyclone filter in the blasting material circuit can be tested. The state and/or level of wear of the blasting material can also be detected.

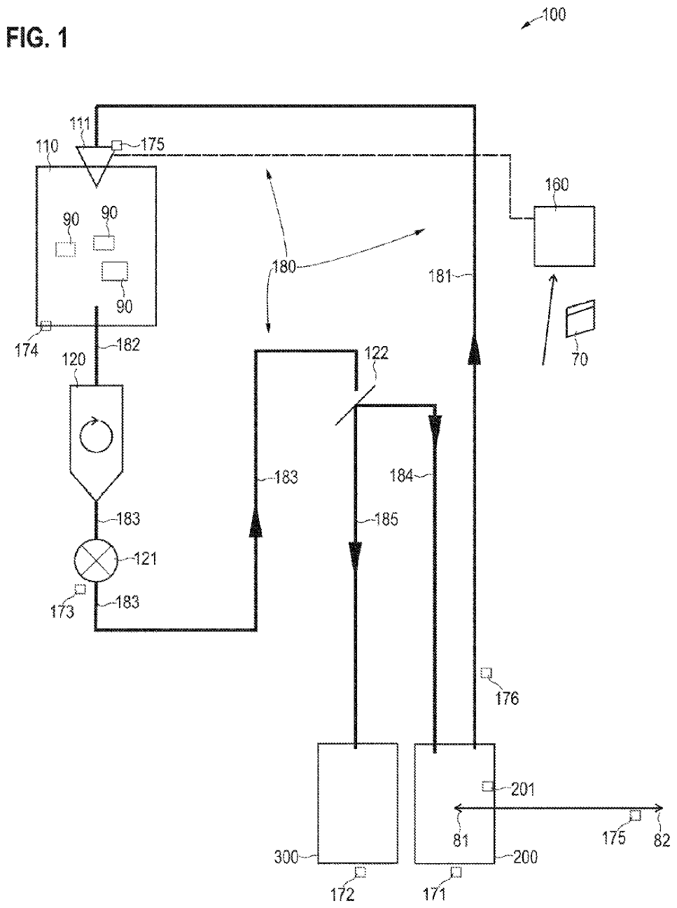

FIG. 1 illustrates aspects associated with a blasting system 100. The blasting system 100 comprises a process chamber 110, into which components 90 can be placed. The components 90 are to be blasted with blasting material in order to treat the surfaces thereof. As an alternative to or in addition to such a treatment of the surfaces of the components 90, it would also be conceivable to de-powder the components 90—for example, in a separate operating mode. To this end, a blasting nozzle 111 is provided which is configured to blast the blasting material into the process chamber. While just a single blasting nozzle 111 is shown in the example from FIG. 1, it would generally be conceivable for more than one blasting nozzle 111 to be used. All of these can be coupled to section 181. In this case, the blasting material is supplied to the blasting nozzle 111 from a blasting material exchange container 200 via a corresponding section 181 of a blasting material circuit 180. The blasting material can be suctioned from the blasting material exchange container via a vacuum, for example, by means of the Venturi effect. A carrier medium can also be used. There may also be blow-off nozzles (not shown in FIG. 1) which clean the process chamber and/or clean the parts.

While only a single blasting material exchange container 200 is shown in FIG. 1, it would generally be possible for several blasting material exchange containers to be used which are optionally coupled to section 181 of the blasting material circuit 180. It would also be conceivable for several infeeds (not only infeed 181) of the blasting material circuit 180 to be present which are simultaneously connected to several blasting material exchange containers (and correspondingly several returns may also be present, not just return 184). In some examples, it would also be conceivable for further sections of the blasting material circuit 180 to be designed in parallel for the various blasting material exchange containers.

The blasting material exchange container 200 can be replenished from time to time so that new blasting material is provided. This means that the blasting material exchange container 200 is detachably arranged in the blasting material circuit.

In the example from FIG. 1, the blasting system 100 has a closed blasting material circuit 180. This means that blasting material removed from the blasting material exchange container 200 is routed back into the blasting material exchange container 200 by means of the blasting material circuit 180 to a certain extent after the material is used in the blasting process. To this end, the blasting material circuit 180 has corresponding sections 182, 183, 184 which lead from the process chamber 110 back to the blasting material exchange container 200. In this case, FIG. 1 illustrates by example that initially the blasting material—which has been displaced with waste and air—is transferred from the process chamber 110 to a cyclone separation unit 120 via a section 182 of the blasting material circuit 180, where solids are then separated from gas or extracted air. The waste may be, for example, powder or powder cake residue and dirt.

The molded parts, which are produced in a powder-based production or printing process, may be produced from a material selected from the group comprising polyamide, particularly polyamide 11 and polyamide 12, thermoplastic polyurethane, aluminum-filled polyamide, particularly aluminum-filled polyamide 12, glass-filled polyamide, carbon-reinforced polyamide, sand, plaster, metal, composite material, and combinations thereof. Such materials typically have particle sizes which are less than the particle sizes of the blasting material by about a factor of from 5 to 10.

A collection container 121 is then located at the outlet of the cyclone separation unit, namely in section 183 of the blasting material circuit 180. The collection container 121 forms a cyclone exit collector. The collection container 121 is used for temporary storage of the mixture of blasting material and waste. A valve—for example a pinch valve—is arranged at the outlet of the collection container 121. This valve can be regulated such that the collection container 121 is not emptied completely so that the flow conditions in the cyclone separation unit 120 are not negatively affected. In addition, a defined quantity of solids can be provided to the separating device 122 by the pinch valve in order to ensure reliable separation over the entire process.

It is then possible to supply this solid mixture of waste and blasting material to a separating device 122 from the collection container 121 via section 183. The waste (for example, the material of a powder cake of a 3D print component which was produced in the LS process) is then separated from the blasting material at the separating device 122—which can be implemented, for example, by a sieve with a vibrating drive (the vibration is decoupled, for example, using rubber or steel springs). The waste is transferred into a waste container 300 via a side section 185 of the blasting material circuit 180, wherein continuous suction away from the blasting system 100 could also take place as a general rule, instead of using a waste container 300. The blasting material is then returned to the blasting material exchange container 200 via section 184 of the blasting material circuit 180. Thus, the blasting material circuit is closed.

The blasting system 100 and the blasting material exchange container 200 are configured to enable an adaptive operation of the blasting system based on control data relating to the blasting material and/or the blasting material exchange container 200. The blasting system 100 has a control logic 160 implemented, for example, as a processor or ASIC. This control logic can receive control data and then control operation of the blasting system 100 based on the control data 70. The control logic 160 can load, for example, control software from a memory and execute it. The control logic can generate control commands and send to the blasting nozzle 111 and/or other components of the blasting system 100. The control logic may implement a human-machine interface via which a user can control the operation of the blasting system 100. In this case, control data can be communicated to the user, for example, via a visual display in the human-machine interface.

The control data 70 can be obtained from a logic element 201 of the blasting material exchange container. The control data 70 can be stored there—e.g. characterizing the type of blasting material, the type of blasting material exchange container, a use-by date of the blasting material, country of origin, filler, a construction type of the blasting material exchange container, and/or specific control commands relating to the operation of the blasting system, just to mention a few examples. Such control data 70 which are permanently stored in a memory do not vary over time during operation of the blasting system. In some examples, it would also be conceivable for the logic element 201 of the blasting material exchange container to comprise a memory, which is writable. In this manner, the operating hours of a blasting material exchange container since the last filling with blasting material can be written into the memory and this value used in order to check whether the operating hours are within a threshold value starting at which it can be assumed that the quality of the blasting material has decreased. In other examples, it would also be conceivable for the control data 70 to be obtained through a measurement and thus very typically as a function of time during operation of the blasting system. To this end, the blasting system 100 and/or the blasting material exchange container 200 has sensors in the example shown, which can implement corresponding state measurements and can transfer corresponding control data 70 a control logic 160 of the blasting system 100, for example via a wireless path. A host of sensors 171-176 are shown in the specific example from FIG. 1, wherein, however, it generally would also be possible for even more sensors to be present but that only a part of the sensors 171-176 is used (or no sensors are present).

Such functional features of the blasting system 100 and of the blasting material exchange container 200 are supplemented in the example from FIG. 1 by means of mechanical-structural features which enable a simple replenishment of the blasting material exchange container 200; in the example from FIG. 1, the blasting system comprises a movable guide element—for example a drawer or a rotating plate—which can be moved back and forth between an operating position 81 and a loading position 82. For the sake of simplicity, the movable guide element is characterized as a drawer in the following but other implementations are also conceivable, however.

The blasting material exchange container 200 is arranged on the drawer and is in the operating position 81 essentially within a housing of the blasting system 100 (as a general rule, however, it would also be conceivable for the blasting material exchange container to also be arranged in the operating position 81 outside of the housing of the blasting system 100); the replenishment of the blasting material exchange container is made possible especially easily in the loading position 82, for example because the blasting material exchange container is then essentially arranged in front of a housing of the blasting system 100 and thus is easy to access. For example, the blasting material exchange container 200 can simply be connected to the blasting material circuit 180 in the loading position 82 or can be separated therefrom, without the blasting material being able to escape. One embodiment of the blasting system may have more than one blasting material exchange container. In this case, the blasting material may be arranged in individual drawers or together in a single drawer.

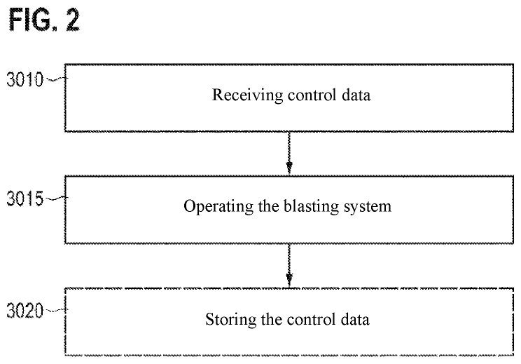

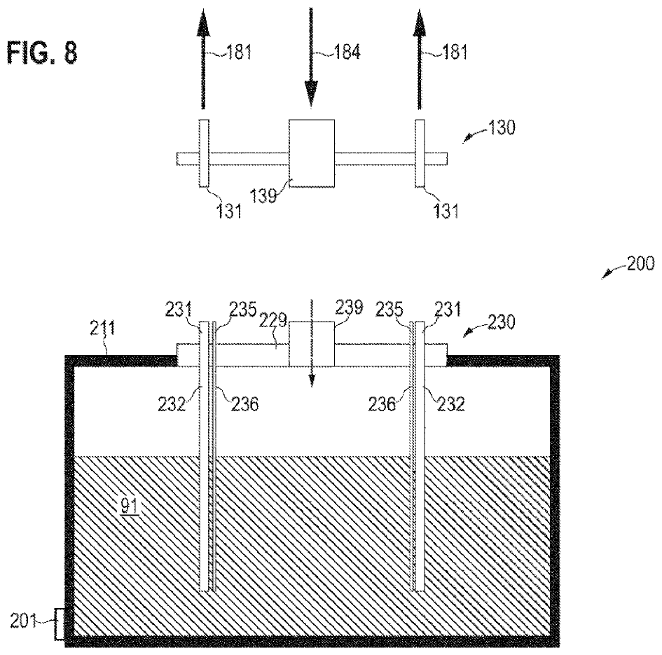

In connection with FIG. 2, various functional features are described initially in the following which enable the adaptive operation of the blasting system in connection with the blasting material. In connection with FIG. 8, various mechanical-structural features are then described in the following which enable the simple replenishment of the blasting material exchange container for the blasting material.

FIG. 2 is a flowchart of an exemplary method. The method can be executed, for example, by the control logic 160 of the blasting system 100. To this end, the control logic 160 can load control commands from a memory and execute them. Optional steps are shown with dashed lines.

The method from FIG. 2 is used to operate the blasting system 100 on the basis of control data (cf. FIG. 1: control data 70), which relates, for example, to the blasting material or the blasting material exchange container 200. To this end, the control data are received initially in block 3010. It is generally possible for control data to be received from different sources which quantify, for example, the current state of operation of the blasting system 100 as relates to the blasting material, for example while considering various observables.

Essentially, it is conceivable for control data to be received from sensors and/or logic elements of the blasting system 100 itself (cf. FIG. 1: sensors 171-176) and, alternatively or additionally, for the control data to be received from sensors and/or logic elements of the blasting material exchange container 200 (cf. FIG. 1: logic element 201).

The operation of the blasting system then takes place in block 3015 based on the control data from block 3010. While the blasting system is operated based on the control data in the example shown, it would also be conceivable in other examples for the control data to simply be stored in a memory (in the blasting material exchange container or the blasting system, for example) or to be transferred, for example, to a server.

The operation of the blasting system may comprise the preparation of a blasting process and/or the implementation of the blasting process. The operation of the blasting system may comprise, for example, the setting of operating parameters such as blasting pressure of the blasting nozzle 111, movement of the components 90 in the process chamber 110, operation of the cyclone separation unit 120, emptying of the buffer element 121 by controlling the pinch valve, separation by means of the separating device 122, selection of a suitable operating mode, for example an error mode, extraction of solids/air from the process chamber, operation of an ionization bar, etc. just to mention a few examples.

During operation of the blasting system, particularly process parameters of the blasting process are set, for example, via a user interface. During operation of the blasting system, the blasting nozzle 111 is actuated, for example, such that it blasts the blasting material into the process chamber 110 of the blasting system 100. The blasting material is then provided via section 181 of the blasting material circuit 180.

As a general rule, the most varied of operating parameters for operating the blasting system can be set based on the control data. The respective operating parameter or parameters, which are set based on the control data, may vary in this case as a function of the type or information content of the control data. Process parameters can either be set automatically based on the control data by a logic stored in the control, set independently of the control data based on a logic stored in the control or based on a parameter memory, and/or set by the operator via the human-machine interface.

In the following, Table 1 describes a few examples of the different information content of the control data.

TABLE 1
Different variants for implementing the control data. In the various examples described
herein, it is conceivable for the variants described in Table 1 to be combined with
one another, i.e. for the most varied types of control data to be received.

| | Information content of | |
|---|---|---|
| Example | the control data | Exemplary implementation |
| A | Type of blasting | Such control data could be provided, for example, by the |
| | material | logic element 201 of the blasting material exchange |
| | | container 200. |
| | | For example, the control data may be indicative of the |
| | | particles contained in the blasting material. For example, |
| | | a chemical composition of the blasting material could be |
| | | indicated. It would be conceivable that, for example, |
| | | abrasiveness is quantified. A serial number which |
| | | uniquely describes the type could be indicated. The type |
| | | of blasting material can be indicated, for example, via a |
| | | link, wherein mass data indicating the details on the type |
| | | of blasting material can be retrieved from a server. |
| B | Weight of the blasting | The control data may be indicative of a weight of the |
| | material or a mixture | blasting material or a mixture containing the blasting |
| | containing the blasting | material at at least one measurement site. |
| | material | For example, the weight of the blasting material could |
| | | be measured in the blasting material exchange container. |
| | | Such a measurement can be implemented, for example, |
| | | by the weight sensor 171 of the blasting system 100, |
| | | which is arranged such that the blasting material |
| | | exchange container 200 is located on the weight sensor |
| | | 171 (or a weighing plate connected thereto) in the |
| | | operating position 81. This measurement could also be |
| | | implemented, however, by a weight sensor integrated |
| | | into the blasting material exchange container. |
| | | Alternatively or additionally, it would be conceivable |
| | | for the weight to be measured at other measurement sites |
| | | along the blasting material circuit, for example, in a |
| | | collection container of the process chamber or the buffer |
| | | element in the blasting material circuit, for example in |
| | | the infeed for the separating unit (cf. FIG. 1, collection |
| | | container 121). The blasting material is then displaced |
| | | with waste there. In order to measure such control data, |
| | | the weight sensors 173, 174 are used, for example, as |
| | | shown in FIG. 1. |
| C | Weight in the waste | It would be possible for the control data to be indicative |
| | container | of a weight of a waste container; cf. FIG. 1, waste |
| | | container 300. Typically, the waste in the waste |
| | | container is composed of powder (for components 90 |
| | | which are produced in the LS process), other dirt, and |
| | | possibly proportions of blasting material. In order to |
| | | measure such control data, the weight sensor 172 of the |
| | | blasting system 100 can be used, for example, which |
| | | weight sensor is arranged under the waste container |
| | | 300 - as shown in FIG. 1. In turn, a weight sensor |
| | | integrated into the waste container could be used. |
| D | Flow rate measurement | For example, it would be conceivable to measure the |
| | | mass flow or volumetric flow of the blasting material in |
| | | the infeed to the blasting nozzle with a corresponding |
| | | sensor. For example, the sensor 176 in section 181 of the |
| | | blasting material circuit 180 could be used; cf. FIG. 1. |
| E | Positioning the blasting | The blasting material exchange container 200 can be |
| | material exchange | separate for the exchange from the blasting material |
| | container | circuit 180. An example is described in connection with |
| | | FIG. 1, in which the blasting material exchange |
| | | container 200 can be moved between an operating |
| | | position 81 and a loading position 82. It would be |
| | | conceivable for the control data to be indicative of the |
| | | position of the blasting material exchange container 200. |
| | | This prevents, for example, a blasting process from |
| | | being started without the blasting material exchange |
| | | container 200 being securely arranged in the operating |
| | | position 81. |
| | | As a general rule, different techniques can be used for |
| | | determining the positioning of the blasting material |
| | | exchange container. For example, a light barrier could |
| | | be used. The weight sensor 171 could also be used with |
| | | consideration of a tare reference which is correlated to |
| | | the dead weight of the blasting material exchange |
| | | container 200. In various examples, however, it would |
| | | also be conceivable for a receiving field strength of the |
| | | control data, which are received from the logic element |
| | | 201 of the blasting material exchange container 200, to |
| | | be indicative of the positioning of the blasting material |
| | | exchange container 200 in the operating position 81. For |
| | | example, an NFC (near field communication) wireless |
| | | path could be used which has a wireless range of a few |
| | | centimeters. In such a case, an NFC readout unit of the |
| | | blasting system 100 could be arranged such that the NFC |
| | | wireless path can then only be established with the logic |
| | | element 201 of the blasting material exchange container |
| | | 200 when the blasting material exchange container is in |
| | | the operating position 81. |
| F | Pressure | The pressure with the blasting nozzle 111 could also be |
| | | measured. This pressure is associated with the type of |
| | | blasting material if this material is being suctioned by |
| | | means of the Venturi effect. Refer to the pressure sensor |
| | | 175 in FIG. 1. |
| G | State of the blasting | The form and color of the media circulating in the |
| | material determined | blasting circuit could be measured by optical sensors in |
| | optically | order to determine, for example, contaminations or the |
| | | quality of the blasting material. |
| H | State of the filter | The state of the filter used to separate the blasting |
| | | material from waste can be monitored with suitable |
| | | sensors. For example, it would be conceivable to |
| | | monitor clogging of the filter. |
| I | Operating parameters of | Such control data could be provided, for example, by the |
| | the blasting system | logic element 201 of the blasting material exchange |
| | | container 200. |
| | | For example, it would be conceivable for specific values |
| | | to be specified for one or more operating parameters of |
| | | the blasting system. Corresponding control commands |
| | | may be contained in the control data. For example, |
| | | operating parameters can be specified which determine |
| | | the use according to one of the examples from Table 2. |

Depending on the information content of the control data, the control data may be used in the most varied of ways to control the operation of the blasting system. Some examples are described in the following in association with Table 2.

TABLE 2
Different ways of setting the operation of the blasting system
as a function of the control data. It is possible for different
variants according to Table 2 to be combined with one another.

| Example | Using the control data | Exemplary implementation |
|---|---|---|
| A | Blasting | Blasting can occur based on the control data. For |
| | | example, it would be conceivable for the blasting nozzle |
| | | for blasting the blasting material to be actuated as a |
| | | function of the control data. |
| | | For example, one or more operating parameters |
| | | associated with the blasting can be specified directly by |
| | | the control data; cf. Table 1, Example I. Such operating |
| | | parameters may comprise the following: movement of the |
| | | blasting nozzles, blasting pressure, blasting strength, |
| | | blasting cycle, switch-on/switch-off of blasting nozzles, |
| | | etc. |
| | | This can also be helpful when the control data indicate the |
| | | type of blasting material; cf. Table 1, Example A. Thus, |
| | | it would be conceivable, for example, for the blasting |
| | | strength - i.e. thus the speed, for example, at which the |
| | | blasting material exits the blasting nozzle - to be set as a |
| | | function of the type of blasting material. For example, an |
| | | exit speed of the blasting material from the blasting |
| | | nozzle 111 could be set via the applied vacuum which |
| | | suctions the blasting material from the blasting material |
| | | exchange container 200; cf. FIG. 1. For example, if |
| | | blasting material with an especially high level of |
| | | abrasiveness is used, it could be desirable, in some |
| | | application scenarios, to reduce the blasting strength. A |
| | | further variant relates to setting the blasting position as a |
| | | function of the type of blasting material. For example, the |
| | | blasting nozzle 111 could be arranged movably in the |
| | | process chamber 110 such that this blasting nozzle is |
| | | arranged closer to or further away from the components |
| | | 90 as a function of the position of the blasting nozzle. |
| | | Depending on the blasting material, it may be desirable to |
| | | set the distance between the blasting nozzle 111 and the |
| | | components 90. It could likewise be helpful to set the |
| | | duration and cycles of the blasting process as a function |
| | | of the type of blasting material. |
| | | However, other monitoring variables may also be used to |
| | | control the blasting, e.g. an aggregated throughput of the |
| | | blasting material or a flow rate of the blasting material. |
| | | For example, a control loop could also be implemented so |
| | | that the flow rate or the aggregated throughput remains |
| | | constant, and the suction vacuum of the blasting nozzle |
| | | can be readjusted accordingly. |
| | | For example, an aggregated throughput may be indicative |
| | | of a blasting material quality because the blasting material |
| | | degrades bit by bit due to use at an increased throughput. |
| | | If several blasting nozzles are present, it would also be |
| | | conceivable for one or more of the blasting nozzles to be |
| | | switched on and one or more of the blasting nozzles to be |
| | | switched off. This can, in turn, take place as a function of |
| | | the control data. For example, different angles or |
| | | distances can thereby be implemented for blasting the |
| | | components depending on the positioning of the |
| | | switched-on or switched-off blasting nozzles. |
| B | Setting boundary | Essentially, the operation of the blasting system can be |
| | operating conditions | controlled via a human-machine interface. In this case, |
| | | different operating parameters can be set in control |
| | | software of the blasting system. It would be conceivable |
| | | for the boundary operating conditions for such operating |
| | | parameters to be set as a function of the control data. For |
| | | example, boundary operating conditions could be set for |
| | | actuating the blasting nozzle - cf. Example A from Table |
| | | 2. The user can then modify the parameter values, for |
| | | example, for the blasting position and blasting strength |
| | | within the boundary operating conditions. Incorrect |
| | | operation can also be prevented by setting the boundary |
| | | operating conditions such that, for example, damage to |
| | | the components 90 can be prevented. Such a setting of the |
| | | boundary operating conditions, for example, for actuating |
| | | the blasting nozzle may be helpful, in particular in |
| | | connection with control data which indicate the type of |
| | | blasting material; cf. Table 1, Example A. |
| C | Error mode | In some cases, an error mode can be triggered as a |
| | | function of the control data. |
| | | The error mode may comprise, for example, the output of |
| | | a warning to the user. A warning or information can be |
| | | generated, for example, acoustically and/or visually via |
| | | the human-machine interface and/or visually via a light |
| | | signal, e.g. in the form of a traffic light signal. |
| | | Alternatively or additionally, the error mode could also |
| | | comprise the output of an operating command to the user |
| | | comprising instructions as to how one or more errors |
| | | triggering the error mode can be eliminated (e.g. |
| | | information as to how to replace the sieve of the |
| | | separating device 122 or how clogging of the cyclone exit |
| | | collector 121 can be resolved, etc.) Alternatively or |
| | | additionally, the error mode could also comprise the |
| | | transmitting of error data to a server, for example to |
| | | enable remote maintenance. |
| | | As a general rule, the most varied of trigger criteria are |
| | | conceivable for triggering the error mode, which are |
| | | based on the control data. For example, different trigger |
| | | criteria may be associated with different types of control |
| | | data according to Table 1. Details related to various |
| | | monitoring aspects which may be used as trigger criteria |
| | | for triggering the error mode are described in the |
| | | following in association with Table 3. |
| D | Separating device or | For example, it would be conceivable for a separating |
| | valve in the infeed of | device to be set for separating blasting material to be |
| | the separating device | returned from waste as a function of the control data. For |
| | | example, a sieve used could be selected as a function of |
| | | control data which are indicative of the type of blasting |
| | | material, for example, in order to adapt a pore size of the |
| | | sieve to the particle size of the blasting material used. The |
| | | operation of a vibrating motor which moves the sieve |
| | | could also be set as a function of the control data. It would |
| | | also be conceivable for a rate at which solids to be filtered |
| | | are supplied to the filter to be set as a function of the |
| | | control data (for example, a rate at which the connection |
| | | container 121 is emptied in section 183 of the blasting |
| | | material circuit 180 in the example from FIG. 1). To this |
| | | end, a valve, e.g. a pinch valve, arranged at the outfeed of |
| | | the collection container 121 can be controlled. For |
| | | example, the weight in the collection container 121 could |
| | | be monitored by means of the weight sensor 173. |
| | | However, the weight in the waste container 300 and/or in |
| | | the blasting material exchange container 200 could also |
| | | be monitored. For example, the control data of optical |
| | | measurements could likewise be included. |
| E | Blasting pressure | The blasting pressure and/or blasting duration of ionized |
| | and/or blasting | air from an ionization bar can be set, for example, as a |
| | duration | function of the type of blasting material. Such techniques |
| | | are based on the fact that different types of blasting |
| | | material may cause electrostatic discharges of different |
| | | strengths, and therefore these parameters can be set |
| | | accordingly. |
| | | It would also be possible for such parameters to be |
| | | specified directly by the control data; cf. Table 1, |
| | | Example I. |
| F | Suction capacity | The strength at which the solid/gas mixture is |
| | | suctioned from the process chamber can be set as a |
| | | function of the control data. For example, this suction |
| | | capacity could be set as a function of the type of blasting |
| | | material combined with the suction strength of the |
| | | blasting nozzles. The suction capacity can be set, for |
| | | example, by setting the operating parameters of a side |
| | | channel compressor fan. |
| | | It would also be possible for such parameters to be |
| | | specified directly by the control data; cf. Table 1, |
| | | Example I. |

The setting of the operation of the blasting system 100—as described in Table 2 for example—is thus based on the control data. In particular, it is possible to monitor the control data. This means that, during operation of the blasting system 100, there can be a repeated check as to whether the control data fulfill certain monitoring criteria.

Some monitoring criteria for monitoring the control data are described in the following. Such monitoring criteria may be used, for example, as trigger criteria which may trigger an error mode—cf. Table 2, Example C. It would also be possible for such monitoring criteria to be used for adapting other operating parameters of the operation of the blasting system 100. Depending on the information content of the control data, different monitoring criteria can be used.

TABLE 3
Different variants for monitoring the control data related to the blasting material.

| Example | Monitoring criterion | Exemplary implementation |
|---|---|---|
| A | Incorrect positioning of | For example, it is possible to detect whether the blasting |
| | the blasting material | material exchange container 200 is in the operating |
| | exchange container | position 81 or not; cf. Table 1, Example E. If not, an |
| | | error mode could be triggered. |
| B | Change in the weight | The change in the weight of the blasting material can be |
| | and/or the fill level | monitored at one or more different measurement sites |
| | | along the blasting material circuit 180, particularly |
| | | within the blasting material exchange container 200. As |
| | | an alternative or in addition to a change in the weight, a |
| | | change in the fill level in the blasting material exchange |
| | | container 200 can also be determined. The weight of the |
| | | blasting material and the fill level of the blasting |
| | | material are related to one another. Examples associated |
| | | with the change in weight are described in the following; |
| | | corresponding examples may also be implemented, |
| | | however, in association with the change in fill level. The |
| | | fill level can generally not only be measured by load |
| | | cells, but also by other types of sensors, e.g., inductive |
| | | sensors, ultrasound sensors, etc. |
| | | To this end, control data can be used, for example, |
| | | according to Example B or Example C from Table 1. |
| | | If the change in the weight is outside of a particular |
| | | predefined range, an error mode could be triggered. For |
| | | example, the observed change in the weight of the |
| | | blasting material could be compared to a predefined |
| | | threshold value. For example, if the weight in the |
| | | blasting material exchange container decreases and falls |
| | | below a predefined threshold value, the error mode can |
| | | be triggered. For example, replenishment of the blasting |
| | | material exchange container could be indicated in the |
| | | event of a low fill level. However, an impurity could also |
| | | be detected, for example based on the monitoring of the |
| | | weight in order to determine an increase in the weight in |
| | | the blasting material exchange container, at least |
| | | temporarily. An unplanned consumption of blasting |
| | | material, e.g. due to an escape from the circuit, could |
| | | likewise be detected via weight measurements. |
| | | The change in weight can not only be considered |
| | | absolutely, e.g. as compared to a reference value, in |
| | | some examples. It would also be conceivable to compare |
| | | the change in weight relative to two different |
| | | measurement sites along the blasting material circuit. |
| | | Thus, it would be conceivable, for example, to compare |
| | | the change in the weight of the blasting material in the |
| | | blasting material exchange container to a change in the |
| | | weight in a buffer element of the blasting material circuit |
| | | (cf. FIG. 1, collection container 121) and/or to a |
| | | change in the weight in the waste container 300. A clog |
| | | or leak can thereby be detected. |
| C | Changes in the flow rate | The change in the flow rate can also be monitored as a |
| | | function of time. To this end, control data can be used |
| | | according to Example D from Table 1. |
| | | A control loop could be implemented such that the |
| | | suction rate is readjusted by setting the vacuum so that |
| | | the flow rate is constant. If the flow rate changes as a |
| | | function of time and is then outside of a predefined |
| | | range, an error mode could be triggered. For example, |
| | | the observed change in the flow rate of the blasting |
| | | material could be compared to a predefined threshold |
| | | value. For example, if the flow rate decreases and falls |
| | | below a predefined threshold value, the error mode can |
| | | be triggered. |
| D | Change in the weight | In addition to a change in the weight, as described in |
| | change | Example B, the second temporal derivation of the |
| | | weight could also be monitored. As an example, it could |
| | | be observed that, during a particular blasting process, |
| | | the weight typically decreases at a particular change rate |
| | | which corresponds to the consumption per unit of time. |
| | | It can then be monitored whether this change rate |
| | | changes, thus the consumption per unit of time varies, |
| | | which may indicate process instabilities. The error mode |
| | | may then be triggered. |
| E | Change in the | The throughput of the blasting material may vary and be |
| | aggregated throughput | monitored accordingly. To this end, control data, for |
| | | example, may also be used which are indicative of the |
| | | weight at a measurement site within the blasting |
| | | material circuit; cf. Table 1, Variant B. A flow rate |
| | | measurement could also be used; cf. Table 1, Variant D. |
| F | Change in the type of | When a new blasting material exchange container 200 is |
| | blasting material | connected, there can be a check to determine whether |
| | | the type of blasting material - as indicated by the control |
| | | data - has changed; cf. Table 1, Example A. |
| | | Optionally, another actuation of the blasting nozzle, for |
| | | example, could then take place; cf. Table 2, Example A. |
| G | Optical state of the | The form and color of the blasting material can enable a |
| | blasting material | statement to be made regarding the state of the blasting |
| | | material. For example, a message could optionally be |
| | | generated which prompts the replenishment of the |
| | | blasting material and/or which pauses the process. |

In block 3020, the control data or variables derived therefrom—for example a blasting material quality, a weight profile, an aggregated throughput, replenishment cycles of the blasting material exchange container, etc. just to mention a few examples—can optionally be stored in a nonvolatile memory. This can make it possible to check, during maintenance, whether particular operating parameters indicated by the control data have changed over time. Optional further parameters can be stored, e.g. user inputs, in block 3020.

Alternatively or additionally, it would also be conceivable in block 3020 for the control data to be transmitted to a central server. Based on the transmitted control data, actions, for example, could also be triggered, for example automatic resupply of a blasting material exchange container as soon as the blasting material has been consumed.

Various techniques associated with the monitoring of the weight at one or more measurement sites along the blasting material circuit 180 are described in the following. Such techniques can be used, for example, in association with Example B from Table 3.

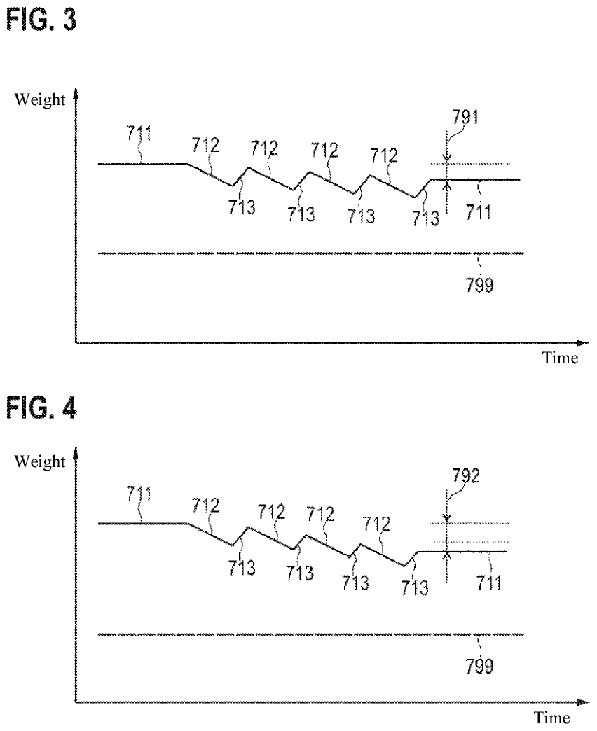

FIG. 3 illustrates aspects associated with the temporal curve of the weight measured at a measurement site in the blasting material circuit 180. For example, FIG. 3 could illustrate the measured variable of the weight sensor 171, i.e. be indicative of the weight of the blasting material located in the blasting material exchange container 200. Corresponding control data 70 can be received from the control logic 160. The weight change in the blasting material exchange container 200 can be monitored; cf. Table 3, Examples B and D.

FIG. 3 shows how the weight tends to decrease as time passes. In rest phases 711, the weight remains constant in the blasting material exchange container 200 because blasting material is not being suctioned nor is blasting material being returned to the blasting material exchange container 200 via section 184 of the blasting material circuit 180. The blasting process is paused during rest phases 711, for example in order to load components 90.

Furthermore, there are time phases 712 during which the weight decreases and time phases 713 during which the weight increases. For example, during times phases 712 and during time phases 713, blasting material is continuously being suctioned from the blasting material exchange container 200 in order to blast the components 90. The blasting material is not returned to the blasting material exchange container 200 continuously in the example from FIG. 3, however, but instead is greater during times phases 713, resulting in the zigzag pattern as shown in FIG. 3. This is due, for example, to a pulsed opening of a pinch valve at the outfeed of the collection container 121 (cf. FIG. 1).

After blasting of the components 90 is complete, there is an aggregated change 791 in the weight of the blasting material in the blasting material exchange container 200. The change could result, for example, from worn-out blasting material getting into the waste container.

It is possible to monitor this aggregated change 791 in weight; cf. Table 3, Variant B. This can then take place in a time-resolved manner (i.e. with a high sampling rate) such that the change in weight is monitored during time phases 712 and 713; however, it would also be conceivable for only the aggregated change 791 to be measured.

It is then possible to control the operation of the blasting system 100 based on the monitoring of the change in weight. For example: The blasting nozzle or blasting nozzles can then be actuated as a function of such monitoring. For example, the suction vacuum could be set such that the aggregated change 791 in weight assumes a particular value. The rate of weight reduction in time phases 712 could also be regulated (i.e. the increase in the curve in time phases 712). For example, a control loop could be implemented based on the measured weight as a measured variable and based on the suction vacuum as a correcting variable. However, an error mode could also be triggered, for example. A different implementation of the control of operation of the blasting system 100 based on monitoring of the change in weight would relate to a threshold value comparison with a predefined threshold value 799. If the weight drops below this threshold value, an error mode can be triggered, for example, in order to prompt the user to replenish the blasting material exchange container 200. An upper threshold value could also be provided, with it being possible to trigger an error mode, for example, when this upper threshold value is exceeded. An increase in weight could be an indicator, for example, of powder and/or waste in the blasting material exchange container and thus indicate, for example, a malfunction in the separating device.

A change in the weight change, i.e. an acceleration or slowing of the weight increase, can also be considered. This is shown in FIG. 4.

FIG. 4 also illustrates aspects associated with the temporal curve of the measured weight of the blasting material in the blasting material exchange container 200. FIG. 4 essentially corresponds to FIG. 3, wherein, however, the aggregated weight reduction 792 is greater in the example from FIG. 4 than in the example from FIG. 3. Due to the monitoring of the change in the aggregated weight reduction 791, 792 of the weight of the blasting material in the blasting material exchange container 200, it could be determined, for example, whether changes occur in the blasting process over time (comparatively slower temporal drift), because, for example, the decrease in weight per unit of time increases. The blasting system can then be operated based on such monitoring of the temporal change in the weight change 791-792. For example, a gradual degradation in the quality of the blasting material could be detected—for example based on impurities or damage to the blasting material. An error mode could then be triggered, for example, which generates a corresponding warning.

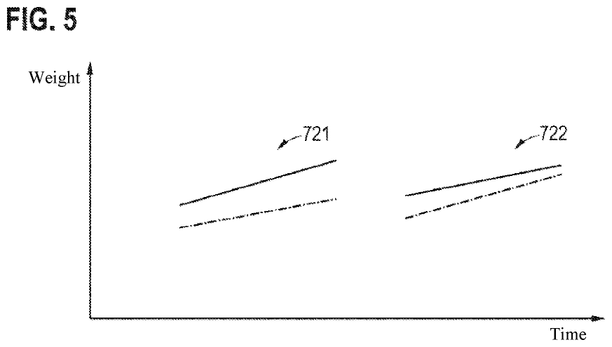

Examples have been described in connection with FIG. 3 and FIG. 4, in which a conclusion regarding an operating state of the blasting system is made possible based on the temporal curve of the weight at an individual measurement site in the blasting material circuit—specifically in the blasting material exchange container 200 in this case. In some examples, it would be conceivable, as an alternative or addition to such monitoring of the weight at a single measurement site, for monitoring of the relative development of the weight to also be implemented at two or more different measurement sites in the blasting material circuit. Thus, a relative change in weight can be implemented. Such a scenario is illustrated in connection with FIG. 5.

FIG. 5 illustrates aspects associated with the temporal curve of the weight measured at two different measurement sites in the blasting material circuit 180. FIG. 5 illustrates an exemplary scenario, in which the weight in the blasting material exchange container 200 (indicated by the solid line in FIG. 5) is monitored—for example by means of the weight sensor 171 of the blasting system 100—and compared to the weight in the waste container 300 (indicated by the dotted-dashed line in FIG. 5)— which is monitored, for example, by means of the weight sensor 172 of the blasting system 100.

In this case, two exemplary scenarios are shown in FIG. 5 for time phases 721 and 722. Time phases 721 and 722 relate to a state in which—for example shortly before the end of the process—no further blasting material is suctioned from the blasting material exchange container 200 but blasting material is still located in the blasting material circuit 180, which blasting material is conveyed back to the blasting material exchange container 200 bit by bit. FIG. 5 illustrates a scenario in which, in normal operation, it is assumed that, for example, the same amount of waste reaches the waste container 300 per unit of time as blasting material reaches the blasting material exchange container 200. During time phases 721, the weight in the blasting material exchange container 200 increases faster than the weight in the waste container 300. This may be an indicator that comparatively much blasting material can be recovered through the separating device 122. On the other hand, the weight in the blasting material exchange container 200 increases more slowly than the weight in the waste container 300 during time phases 722. This may be an indicator that comparatively little blasting material can be recovered through the separating device 122. For example, it would be conceivable in such a case to trigger an error mode which advises a user of a possible clogging of the sieve of the separating device 122. Within the scope of such an error mode, the vibrating drive of the sieve of the separating device 122 can be actuated in an enhanced manner for a short time in order to eliminate clogging of the sieve. The cycle of emptying the collection container 121 could also be adjusted based on the separating device 122. A compressed air nozzle installed at the sieve could be activated.

In general terms, the monitoring of the change in weight of the blasting material in the blasting material exchange container 200 may thus comprise, in particular, the implementing of a comparison of this change in weight of the blasting material in the blasting material exchange container 202 to a change in weight in the waste container 300 and/or at a different measurement site in the blasting material circuit—for example the buffer element 121.

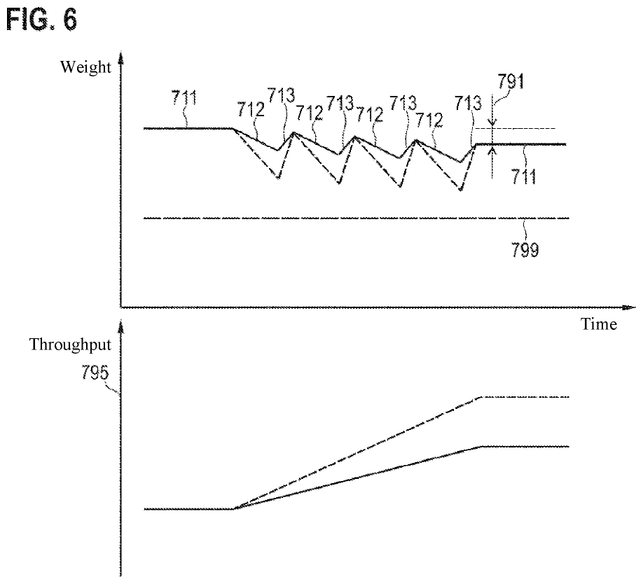

FIG. 6 illustrates aspects associated with the temporal curve of the measured weight of the blasting material in the blasting material exchange container 200. In particular, FIG. 6 illustrates, in turn, how the weight changes as a function of time for time phases 711-713. In this case, FIG. 6 illustrates, at top, two scenarios (indicated by a solid line and dashed line). The example from FIG. 6 shows that, despite a significantly different aggregated throughput 795 of the blasting material (measured, for example, in the form of an implemented weight or an implemented volume), the aggregated change 791 over the blasting process is identical for both scenarios. Therefore, it may be desirable to determine the aggregated throughput 795 (see FIG. 6, at bottom) and to control the operation of the blasting system 100 on the basis of this aggregated throughput 795; cf. Table 3, Variant E. The aggregated throughput can be measured by a comparatively quick sampling of the weight with a time resolution that is greater than the duration of the preliminary time phases 712, 713 or, for example, by a flow rate sensor.

The aggregated throughput 795 may be indicative, for example, of a blasting material quality. The reason for this is that the blasting material becomes increasingly degraded as the throughput of the blasting material increases.

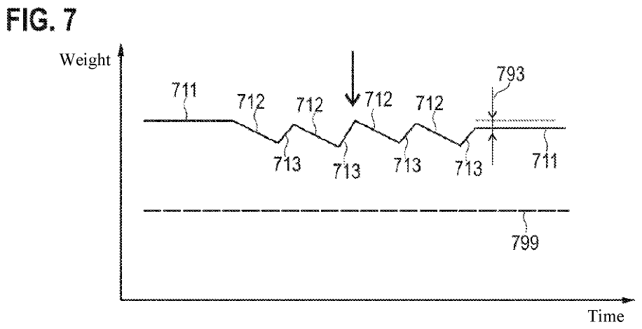

FIG. 7 illustrates aspects associated with the temporal curve of the weight of the blasting material in the blasting material exchange container 200. In particular, FIG. 7 illustrates, in turn, how the weight changes as a function of time for time phases 711-713. A sudden increase in the weight in the blasting material exchange container 200 occurs in the example from FIG. 7—indicated by the vertical arrow. In the various examples described herein, it would be possible to detect such an increase in weight in the blasting material exchange container 200 within the scope of weight monitoring. For example, an error mode could be triggered in such a case, for example, because such a sudden increase in the weight may indicate an external contaminant.

FIG. 8 illustrates aspects associated with the blasting material exchange container 200 (sometimes also referred to as a cartridge). The blasting material exchange container 200 comprises a canister 211, which is partially filled with blasting material 91. The canister 211 has an opening, into which a connecting element 230 is inserted in the example from FIG. 8, such that the opening is closed off by the connecting element 230. In this case, it is possible to remove the connecting element 230 from the opening, for example, when the blasting material 91 is being refilled into the canister 211. A closure plate 229 of the connecting element 230 could be screwed, for example, into a corresponding thread on an inner side or outer side of the opening of the canister 211. This closure plate could be completely closed by a suitable cover (not shown) after filling of the blasting material and/or during storage and transport.

FIG. 8 shows that two suction lances 232 extend from the closure plate 229 into the interior of the canister 211 such that the blasting material 91 can be suctioned through a base opening in the suction lances 232.

To this end, connecting element 230 has two coupling nozzles 231, which are both fluidly coupled to one of the suction lances 232 and extend away from the closure plate 239 into the environment of the blasting material exchange container 200. The coupling nozzles 231 are configured to produce a sealing connection between respective suction lance 232 and the blasting material circuit 180, wherein this is done via corresponding coupling nozzles 131 of connecting element 130 of the blasting system 100.

The coupling nozzles 131 are both connected to section 181 of the blasting materials circuit 180.

Coupling nozzles 131 of connecting element 130 can be connected to coupling nozzles 231 of connecting element 230 in a movement operation, for example, due to placement of connecting element 130 on connecting element 230. It is not necessary to separately position each of coupling nozzles 131 on corresponding coupling nozzle 231 of connecting element 230. The blasting material exchange container 200 can thereby be connected to the blasting material circuit 180 especially quickly. In addition, both suction lances 232 could have a single common coupling nozzle, whereby connecting element 130 likewise could only have one coupling nozzle for connection to the blasting material circuit 180.

In addition, FIG. 8 shows that an inlet 239 is arranged in the closure plate 229. This inlet is suitable for returning blasting material from the blasting material circuit 180—particularly section 184—into the interior of the canister 211. To this end, a corresponding coupling nozzle is provided which can engage a corresponding coupling nozzle 139 of connecting element 130. Thus, the blasting material circuit 180 can be closed by placing connecting element 130 onto connecting element 230.

The blasting material exchange container 200 can be easily connected to the blasting material circuit 180 due to such a design of connecting element 230 or corresponding connecting element 130—having suitable coupling nozzles 131, 231 or 139, 239. Connecting element 130 can be placed onto connecting element 230. A special tool is not required.

In particular, this connection of the connecting elements 130, 230 can take place in the loading position 82—for example with the drawer extended (cf. FIG. 1). To this end, flexible hoses can be connected to the coupling nozzles 131, which flexible hoses are dimensioned long enough to enable movement of the blasting material exchange container 200 with the connected connecting elements 130, 230 from the operating position 81 into the loading position 82. In this manner, connecting element 130 can be placed onto connecting element 230 or disconnected therefrom when the blasting material exchange container 200 is in the loading position 82.

The example from FIG. 8 also shows that lines 236 extend respectively along the suction lances 232, which lines extend through the closure plate 229 and thus can guide ambient air to the end of the suction lances 232. The lines 236 have about the same length within the canister 211 as the suction lances 232. A vacuum otherwise resulting at the end of the suction lances 232, due to the suctioning by means of a vacuum, can thereby be compensated for. This makes it possible to suction the blasting material especially evenly and reliably without the risk of clogging. Instead of ambient air, air from the blast material circuit or other elements of the blasting system could also be used.

In summary, a system has been described previously comprising a blasting system and a blasting material exchange container. The system enables easy replenishment of the blasting material with minimal operator contact. The blasting material quality can be monitored continuously, for example, using weight monitoring. It would also be conceivable for the blasting material quality and the progression thereof to be monitored, optionally recorded, and made accessible to the operator. The user can thereby be informed of the state of the blasting material.

In the techniques described, communication can be enabled between the blasting material exchange container and the blasting system, for example via an RFID system, in which a chip on the blasting material exchange container (sometimes also referred to as the cartridge) stores control data related to the blasting material, which control data are recorded by a system-side (writer) reader (cf. FIG. 1).

In addition to such functional features, mechanical-structural features relating to the connecting elements of the blasting material exchange container as well as the blasting system are described above which enable a sealed connection between the blasting material exchange container and the blasting material circuit of the blasting system (cf. FIG. 8).

This connection can be produced without special mechanical tools, for example simply by placing coupling nozzles of the connecting elements on top of one another. Screwing or clamping or other types of connections are also possible.

An opening of the canister of the blasting material exchange container may have a thread, onto which a closure plate of a connecting element is screwed after the blasting material has been replenished, which closure plate fixes one or more suction lances in position. The suction lances may extend into an interior of the canister. The other side of the closure plate may have a coupling nozzle for establishing a quick connection to a corresponding coupling nozzle of a corresponding connecting element of the blasting system.

The at least one suction lance may be placed in the container during filling since insertion of a suction lance can be difficult after filling.

By means of the at least one suction lance, the blasting material can be conveyed from the blasting material container under vacuum.

It has also been described that monitoring of the weight can take place not only in connection with the blasting material exchange container but, alternatively or additionally, the weight monitoring can also take place at other points along the blasting material circuit. In particular, it would be conceivable for the waste container to also be monitored for dirt and powder (for example via weight monitoring).

The monitoring system can likewise be used to control the blasting process. When the content of the container is continuously monitored (for example through weighing), changes and progression can also be monitored.

Various effects can be achieved using such techniques. The replenishment of blasting material is simple and involves minimal contact between the operator and the blasting material. No or few manual adaptations of process or system parameters are necessary (according to the type of blasting material and the degree of wear/age of the blasting material). Incorrect operation is prevented (for example due to excessively long use of blasting material or use of incorrect blasting material). A uniform process stability and quality of parts is ensured. Quality problems can be tracked by logging the blasting material quality and replenishment cycles (cf. FIG. 2, block 3020).

Automatic warnings can be generated (e.g. when the blasting material container is empty) or, in general, one or more error modes can be triggered.

Additional functions can be ensured by integrating weight sensors (load cells) or other sensors for determining fill levels (not only in the blasting material and waste containers but also in the cyclone exit collector): correct loading of the sieve 122; ensuring a defined barrier of solids in the cyclone exit collector 121 to ensure correct flow conditions in the cyclone separation unit and the entire system; preventing overloading of the cyclone separation unit; preventing overloading of the waste container and/or the blasting material exchange container.

### EXAMPLES

In summary, the following examples have been described previously.
Example 1. A method for operating a control logic of a blasting system (100), wherein the blasting system (100) comprises at least one blasting nozzle (111) for blasting blasting material (91) into a process chamber (110) of the blasting system (100), wherein at least one component (90) can be arranged in the process chamber (110), wherein the blasting material (91) is supplied to the at least one blasting nozzle (111) from a blasting material exchange container (200) via a blasting material circuit (180, 181-185) of the blasting system (100), wherein the method comprises:
   receiving (3010) control data (70) from a logic element (201) of the blasting material exchange container (200) which is detachably arranged in the blasting material circuit (180, 181-185), and
   operating (3015) the blasting system (100) based on the control data (70).
Example 2. The method according to Example 1, which further comprises:
   controlling the blasting of blasting material based on the control data (70).
Example 3. The method according to Example 2,
wherein the blasting system (100) comprises several blasting nozzles (111),
wherein control of the blasting of the blasting material comprises the switch-on or switch-off of individual ones of the several blasting nozzles based on the control data (70).
Example 4. The method according to Example 2 or 3,
wherein control of the blasting of the blasting material comprises the setting of at least one of a blasting strength, a blasting duration, or a blasting position of the at least one blasting nozzle.
Example 5. The method according to any of the preceding examples,
wherein the control data (70) are indicative of a type of blasting material (91) and/or indicate one or more operating parameters of the blasting system (100).
Example 6. The method according to any of the preceding examples, which further comprises:
   setting of one or more boundary operating conditions for operating (3015) the blasting system in control software of the blasting system (100) based on the control data (70).
Example 7. The method according to any of the preceding examples, which further comprises:
   selective triggering of an error mode of the blasting system (100) based on the control data (70). Example 8. The method according to any of the preceding examples,
wherein the control data (70) are received from the logic element (201) of the blasting material exchange container (200) via a near field wireless path,
wherein a receiving field strength of the control data (70) is indicative of the positioning of the blasting material exchange container (200) in an operating position (81) in relation to the blasting system (100).
Example 9. The method according to any of the preceding examples, which further comprises:
   optional suctioning of the blasting material from the blasting material exchange container and/or of further blasting material from a further blasting material exchange container based on the control data.
Example 10. The method according to any of the preceding examples, which further comprises:
   receiving (3010) further control data (70) from a sensor (171) of the blasting system (100), wherein the further control data (70) are indicative of a weight of the blasting material (91) in the blasting material exchange container (200),
wherein the blasting system (100) is operated, furthermore, based on the further control data (70).
Example 11. The method according to any of the preceding examples,
wherein the control data (70) are indicative of a weight of the blasting material (91) in the blasting material exchange container (200).
Example 12. The method according to Example 10 or 11, wherein the method further comprises:
   monitoring of a change (791, 792) in the weight of the blasting material (91) in the blasting material exchange container (200) during operation of the blasting system (100),
wherein the blasting system (100) is operated based on monitoring of the change (791, 792) in the weight of the blasting material (91) in the blasting material exchange container (200).
Example 13. The method according to Example 12,
wherein the monitoring of the change (791, 792) in the weight of the blasting material (91) in the blasting material exchange container (200) comprises monitoring of a change in the weight change (791, 792) and/or monitoring of an aggregated throughput (795) of the blasting material (91).
Example 14. The method according to Example 12 or 13,
wherein the monitoring of the change (791, 792) in the weight of the blasting material (91) in the blasting material exchange container (200) comprises the implementing of a comparison of the change (791, 792) in the weight of the blasting material (91) in the blasting material exchange container (200) to a change in the weight in a buffer element (110, 121) in the blasting material circuit (180, 181-185) and/or to a change in the weight in a waste container (300) of the blasting material circuit (180, 181-185).
Example 15. The method according to any of Examples 12 to 14,
wherein the monitoring of the change (791, 792) in the weight of the blasting material (91) in the blasting material exchange container (200) comprises the detecting of an increase in the weight of the blasting material (91) in the blasting material exchange container (200).
Example 16. The method according to any of Examples 12 to 15, wherein the monitoring of the change (791, 792) in the weight of the blasting material (91) comprises the detecting of a decrease in the weight of the blasting material (91) in the exchange container subject to a predefined threshold value (799).
Example 17. The method according to any of the preceding examples,
wherein the blasting system (100) further has a valve which is arranged at the outfeed of a collection container (121) in the blasting material circuit between the process chamber (110) and a separating device (122) for separating the blasting material from waste,
wherein the method further comprises:
   controlling the valve based on the control data (70).
Example 18. A blasting system (100) which comprises a control logic, a process chamber (110), and at least one blasting nozzle (111), wherein the at least one blasting nozzle (111) is configured for blasting blasting material (91) into the process chamber (110), wherein at least one component (90) can be arranged in the process chamber (110), wherein the blasting material (91) is supplied to the at least one blasting nozzle (111) from a blasting material exchange container (200) via a blasting material circuit (180, 181-185) of the blasting system (100),
wherein the control logic (160) is configured to execute the following steps:
   receiving (3010) control data (70) from a logic element (201) of the blasting material exchange container (200) which is detachably arranged in the blasting material circuit (180, 181-185), and
   operating (3015) the blasting system (100) based on the control data (70).
Example 19. A blasting material exchange container (200), which comprises:
   a canister (211) which is configured to receive blasting material (91), and
   a connecting element which is attached to the canister (211) and which comprises:
   a closure plate (229) which closes off an opening in the canister (211),
   at least one suction lance (232) which extends through the closure plate (229) into the canister (211) and which is configured to suction the blasting material (91) into a blasting material circuit (180, 181-185) of a blasting system (100) by means of a vacuum, as well as
   at least one coupling nozzle (231) which is fluidically coupled to the at least one suction lance (232) and which is arranged outside of the closure plate (229) as relates to the canister (211), and which is configured to produce a sealing connection of the suction lance (232) with the blasting material circuit (180, 181-185) of the blasting system (100) via at least one corresponding coupling nozzle (131) of the blasting system (100).
Example 20. The blasting material exchange container (200) according to Example 19,
wherein the connecting element (230) further comprises:
   an inlet which is arranged in the closure plate (229) and which is configured to return blasting material (91) from the blasting material circuit (180, 181-185) to the canister (211), and
   a further coupling nozzle (239) which is coupled to the inlet and which is arranged outside of the closure plate (229) as relates to the canister (211).
Example 21. The blasting material exchange container (200) according to Example 19 or 20,
wherein the connecting element (230) further comprises:
   at least one line (236) which extends into the canister (211) along the at least one suction lance (232) outside of the closure plate (229) as relates to the canister (211) and which is configured to supply ambient air to a region at the end of the suction lance (232).
Example 22. The blasting material exchange container (200) according to any of Examples 19 to 21, which further comprises:
   a logic element (201) which is configured to transfer control data (70) to a blasting system (100).
Example 23. A system which comprises:
   the blasting material exchange container (200) according to any of Examples 19 to 22,
   the blasting system (100) which comprises a further connecting element (130) which is configured to connect the at least one coupling nozzle (231) to the blasting material circuit (180, 181-185) in a sealing manner by means of a corresponding at least one coupling nozzle (131).
Example 24. A blasting system (100) which comprises:
   a process chamber (110) which is configured to receive at least one component (90),
   at least one blasting nozzle (111) which is configured to blast the blasting material (91) into the process chamber (110),
   a blasting material circuit (180, 181-185) which is configured to convey the blasting material (91) to the at least one blasting nozzle (111) and to discharge it from the process chamber (110), and
   a connecting element (130) with at least one coupling nozzle (131) which is configured to produce a sealing connection between at least one suction lance (232) of the blasting material exchange container (200) and the blasting material circuit (180, 181-185) via at least one corresponding coupling nozzle (231) of a blasting material exchange container (200).
Example 25. The blasting system (100) according to Example 24, which further comprises:
   a movable guide element which can be moved between a loading position (82) and an operating position (81) and which is configured to receive the blasting material exchange container (200),
wherein the connecting element (130) is connected to the blasting material circuit (180, 181-185) via at least one movable hose which is dimensioned to connect the blasting material exchange container (200) to the blasting material circuit (180, 181-185) both in the loading position (82) and in the operating position (81).
Example 26. The blasting system (100) according to Example 25, which further comprises:
   a weight sensor (171) which is arranged such that the blasting material exchange container (200) rests against the weight sensor (171) in the operating position (81) and/or the loading position (82).
Example 27. A blasting material exchange container (200), which comprises:
   a canister (211) which is configured to receive blasting material (91) for a blasting system, and
   a logic element (201) which is configured to transfer control data (70) to the blasting system (100).
Example 28. A blasting system (100) with a closed blasting material circuit, which comprises:
a process chamber (110) which is configured to receive at least one component (90),
at least one blasting nozzle (111) which is configured to suction blasting material (91) along the blasting material circuit and to blast it into the process chamber (110),
a collection container (121) which is arranged along the blasting material circuit, downstream starting from the process chamber, and
a valve at an outlet of the collection container (121) which, upon opening, is configured to supply blasting material along the blasting material circuit to a separating device which is configured to separate the blasting material from waste.
Example 29. The blasting system (100) according to Example 28, which further comprises:
   a control logic (160) which is configured to control the valve based on control data.
Example 30. The blasting system (100) according to Example 28 or 29,
wherein the collection container (121) is designed as a cyclone exit collector of a cyclone separation unit (120).

Obviously, the features of the previously described embodiments and aspects of the invention can be combined with one another. In particular, the features not only can be used in the described combinations but also in other combinations or in isolation without extending beyond the scope of the invention.

For example, various examples have been described previously in which the blasting system is connected to only one blasting material exchange container. As a general rule, it would be conceivable for the blasting material circuit to have branches which enable the blasting system to be connected to several blasting material exchange containers. The various blasting material exchange containers may be filled with different types of blasting material. For example, the fact that the type of blasting material is communicated by the corresponding logic element of the blasting material exchange container of the blasting system (cf. Table 1, Example A) ensures that the correct blasting material is selected for blasting—without the user having to note the specific positioning of the various blasting material exchange containers. The use of different types of blasting material in a blasting system can then be enabled without having to change the blasting material.

Various examples have also been described previously which relate to the use of a blasting system to blast components produced by means of the LS method. However, corresponding techniques can also be used in association with the blasting of other components.

Various examples have been described previously in association with an implementation of a connection between the blasting system and the blasting material exchange container via connecting elements, wherein a connecting element assigned to the blasting material exchange container comprises one or more suction lances. As a general rule, it would also be conceivable that the one or more suction lances are not arranged at the connecting element assigned to the blasting material exchange container but at a connecting element which is assigned to the blasting system (cf. FIG. 8, connecting element 130). The suction lances can then protrude through openings in a closure plate of the connecting element which is assigned to the blasting material exchange container.

Furthermore, various examples have been described previously in which there is only one blasting nozzle. As a general rule, a plurality of blasting nozzles can be used per blasting system.

Various examples have been described previously in which the operation of the blasting system is set based on the control data. As a general rule however, it would also be conceivable for the control data to be stored or transferred to a server, for maintenance purposes for example, without directly impacting the operation of the blasting system.

Examples have been described previously in which control data are read from a logic element of a blasting material exchange container. In some examples, it would also be possible for the control data to be modified in the logic element of the blasting material exchange container. For example, it would be conceivable for the operating hours or the throughput volume etc. of blasting material in the blasting material exchange container to be logged as well in the logic element of the blasting material exchange container. This can prevent, for example, a previously extensively used blasting material from inadvertently being reused in a different blasting system.

Techniques have been described previously in which a blasting material exchange container is used. The blasting system can also be controlled based on control data without the use of an exchange container as described.

1-15. (canceled)

16. A method of operating a control logic of a blasting system,
wherein the blasting system comprises at least one blasting nozzle for blasting of blasting material into a process chamber of the blasting system,
wherein at least one component can be arranged in the process chamber,
wherein the blasting material is supplied via a closed blasting material circuit of the blasting system,
wherein the method comprises:
receiving control data from at least one sensor arranged along the blasting material circuit, and
operating the blasting system based on the control data.

17. The method according to claim 16,
wherein the blasting material is guided via a collection container arranged along the blasting material circuit,
wherein said operating of the blasting system based on the control data comprises controlling a valve arranged at an outfeed of the collection container,
wherein the valve, when opened, provides the blasting material to a separating device which is configured to separate the blasting material from waste.

18. The method according to claim 16,
wherein the at least one sensor is arranged at one or more measurement sites along the blasting material circuit,
wherein the at least one sensor comprises a weight sensor, and
wherein said operating of the blasting system based on the control data comprises monitoring a change of the weight.

19. The method of claim 18,
wherein the blasting material is supplied via a collecting container arranged along the blasting material circuit,
wherein the collecting container is a buffer element in the blasting material circuit and comprises blasting material that has been previously separated from waste,
wherein the weight sensor measures the weight of the blasting material in the buffer element,
wherein said operating of the blasting system based on the control data comprises monitoring a change of the weight.

20. The method of claim 18, further comprising:
triggering an error mode of the blasting system based on said monitoring of the change of the weight.

21. The method of claim 16, further comprising:
controlling said blasting of the blasting material based on the control data.

22. The method according to claim 21,
wherein the blasting system comprises multiple blasting nozzles,
wherein said controlling of the blasting of the blasting material comprises a switch-on or a switch-off of individual ones of the multiple several blasting nozzles based on the control data, and/or
wherein said control of said blasting of the blasting material comprises setting of at least one of a blasting strength, a blasting duration, or a blasting position of the at least one blasting nozzle.

23. The method of claim 16,
wherein the control data are indicative of a type of blasting material and/or are indicative of one or more operating parameters of the blasting system.

24. The method of claim 23,
wherein the control data are received via a near-field wireless path.

25. A blasting system comprising a closed blasting material circuit and further comprising:
a process chamber configured to receive at least one component,
at least one blasting nozzle configured to suction blasting material along the blasting material circuit and to blast the blasting material into the process chamber,
a control logic configured to operate the blasting system based on control data determined based on a measurement of at least one sensor arranged along the blasting material circuit.

26. The blasting system according to claim 25, further comprising:
a collection container arranged along the blasting material circuit, downstream from the process chamber, and
a valve at an outlet of the collection container which, upon opening, is configured to supply blasting material along the blasting material circuit to a separating device which is configured to separate the blasting material from waste,
wherein the control logic is configured to control the valve based on the control data.

27. The blasting system according to claim 26,
wherein the collection container is a cyclone exit collector of a cyclone separation device.

28. The blasting system of claim 26,
wherein the valve is a pinch valve,
wherein the sensor is an inductive sensor.

29. The blasting system according to claim 28,
wherein the at least one sensor is configured to measure a change of a weight at one or more measuring points along the blasting material circuit.

30. The blasting system according to claim 25, further comprising:
a collection container arranged along the blasting material circuit, downstream from the process chamber,
wherein the at least one sensor is configured to measure a change of a weight of the blasting material that has been separated from waste in the collecting container.

31. A system, comprising:
the blasting system of claim 25, and
the at least one sensor.
